(19) United States
(12) Patent Application Publication
(10) Pub. No.: US 2005/0093819 A1
(43) Pub. Date: May 5, 2005

(54) Mobile communication terminal and data transmission method of the same

(75) Inventor: Sung-Sik Wang, Anyang-Si (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 10/820,879

(22) Filed: Apr. 9, 2004

(30) Foreign Application Priority Data
Oct. 29, 2003 (KR) 2003-76064
Dec. 29, 2003 (KR) 2003-98506

(51) Int. Cl. G09G 5/00

(52) U.S. Cl. 345/156; 345/549; 345/605

(57) ABSTRACT

A color display data transmission technology of a mobile communication terminal, and more particularly a method for transmitting color display data using address pins of a main processor mounted in a mobile station modem (MSM) chip and a mobile communication terminal adopting the method. In the mobile communication terminal, the main processor and a liquid crystal display (LCD) driver are interconnected by a plurality of data pins and a number of address pins. The main processor divides color display data of each dot expressed as n bits, and carries out a control operation so that partial bit data of the divided color display data is outputted through the data pins, and simultaneously the remaining bit data of the divided color display data is outputted through some of the address pins. The LCD driver collects the n-bit color display data transmitted through the data pins and some of the address pins, and stores the color display data in a predetermined area on a dot-by-dot basis.

### BACKGROUND OF THE INVENTION

1. Field of the Invention

The present invention relates to a mobile communication terminal, and more particularly to a mobile communication terminal and a data transmission method of the same.

2. Description of the Related Art

With the development of wireless data transmission technologies, mobile communication terminals recently provide various multimedia functions such as moving picture/graphic/audio transmission services and image communication as well as a voice call. In order to meet a need for the multimedia function, the mobile communication terminals adopt a color liquid crystal display (LCD) device.

Currently available color phones, differently from initial model phones, are equipped with a 65 K color thin film transistor liquid crystal display (TFT-LCD). In case of 65 K color phones, a main processor mounted in a controller such as a mobile station modem (MSM) chip transmits 16-bit color display data to an LCD driver through 16 data pins. This will be described in detail with reference to FIG. 1.

FIG. 1 is a schematic diagram illustrating data pins used for transmitting color display data to a liquid crystal display (LCD) driver in a conventional mobile communication terminal. As shown in FIG. 1, a main processor 100 mounted in the MSM chip transmits 16-bit color display data to an LCD driver 200 through 16 data pins D0 to D15. In FIG. 1, A0, A1, . . . denote address pins of the main processor 100. The main processor 100 and the LCD driver 200 can determine whether data communicated through one of the address pins is control data or display data. For example, the LCD driver 200 shown in FIG. 1 checks a status signal transmitted from the address pin Al of the main processor 100 to an address pin C so that a determination can be made as to whether data transmitted from a data pin of the main processor 100 is display data or control data such as screen brightness control data. For reference, CS shown in FIG. 1 denotes a pin for outputting a chip select/enable signal.

On the other hand, terminal manufacturers are implementing, for example, a 260 k color TFT LCD rather than 65,000 colors so that the demands of various users can be met and the product competitiveness can be ensured. However, the number of data pins assigned for transmitting display data in the conventional MSM chip is limited to only 16. Thus, to support the 260 K colors (or 18-bit LCD), the conventional MSM chip must transmit 16-bit display data and 2-bit display data through the 16 data pins or must transmit two pieces of 9-bit display data, through twice transmissions. This means that the transmission time required for transmitting the display data increases two-fold. Considering the fact that the LCD consists of several thousand dots and the number of dots can be generally being increased, there is a problem in that a time period required for transmitting the display data can be increased when the 260 K or more colors are implemented. That is, a data transmission rate is lowered.

### SUMMARY OF THE INVENTION

It is an object of the present invention to provide a mobile communication terminal and a data transmission method that can reduce a time period required to transmit display data by transmitting part of the display data to a liquid crystal display (LCD) driver using address pins.

It is another object to provide a mobile communication terminal that can transmit part of display data to a liquid crystal display (LCD) driver through address pins of a main processor or through global purpose input/output (GPIO) pins.

In accordance with one aspect of the present invention, the above and other objects can be accomplished by the provision of a mobile communication terminal in which a main processor including a plurality of data pins and a plurality of address pins and transmitting predetermined bits of color display data through the data pins and the address pins; and a liquid crystal display (LCD) driver receiving the predetermined bits of the color display data transmitted through the data pins and the address pins and driving a liquid crystal display (LCD) device according to the received color display data.

Preferably, the main processor and the LCD driver may set one address pin as a signal transmission pin necessary for discriminating a color display data transmission and a control data transmission, respectively, such that bit data received through some of the address pins is determined to be part of the color display data when the LCD driver receives a color display data transmission signal through the set signal transmission pin.

Preferably, the color display data of each dot may be 18-bit data, 16-bit color display data may be transmitted through 16 data pins, and 2-bit color display data may be transmitted through 2 address pins, such that 260 K colors can be expressed on the basis of the color depth per dot corresponding to 18 bits.

In accordance with another aspect of the present invention, the above and other objects can be accomplished by the provision of a mobile communication terminal in which a main processor including a plurality of data pins, a plurality of address pins and a plurality of global purpose input/output (GPIO) pins and transmitting predetermined bits of color display data through the data pins and the GPIO pins; and a liquid crystal display (LCD) driver receiving the predetermined bits of the color display data transmitted through the data pins and the GPIO pins and driving a liquid crystal display (LCD) device according to the received color display data.

In accordance with yet another aspect of the present invention, the above and other objects can be accomplished by the provision of a method for transmitting color display data in a mobile communication terminal including a main processor connected to a liquid crystal display (LCD) through data pins and address pins, comprising the steps of: outputting a color display data transmission signal to the LCD driver through one of the address pins; dividing color display data to predetermined bits; and transmitting partial bit data of the divided color display data to the LCD driver through the data pins and the remaining bit data of the divided color display data to the LCD driver through some of the address pins.

When part of the color display data is transmitted using the address pins other than the data pins allowable in a mobile station modem (MSM) chip, a terminal of the present invention can effectively display various colors in comparison with a conventional terminal only using the data pins.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating data pins used for transmitting color display data to a liquid crystal display (LCD) driver in a conventional mobile communication terminal;

FIG. 2 is a schematic diagram illustrating address pins used for transmitting color display data to a liquid crystal display (LCD) driver in accordance with an embodiment of the present invention;

FIG. 3 is a flow chart illustrating a method for transmitting the color display data in accordance with an embodiment of the present invention; and

FIG. 4 is a schematic diagram illustrating pin usage in accordance with another embodiment of the present invention.

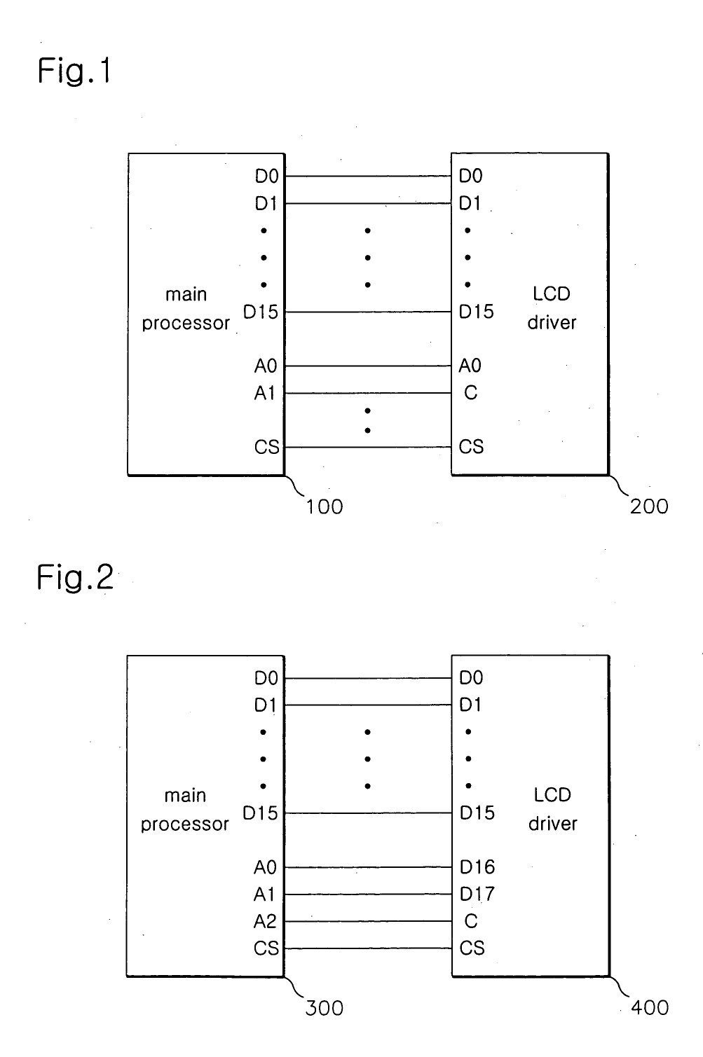

### DESCRIPTION OF THE PREFERRED EMBODIMENTS

Now, preferred embodiments in accordance with the present invention will be described in detail with reference to the annexed drawings. Furthermore, in the following description of the present invention, a detailed description of known functions and configurations incorporated herein will be omitted when it may make the subject matter of the present invention rather unclear. It is assumed that a main processor 300 mounted in a mobile station modem (MSM) chip is connected to a liquid crystal display (LCD) driver 400 by 16 data pins and 3 address pins in this specification.

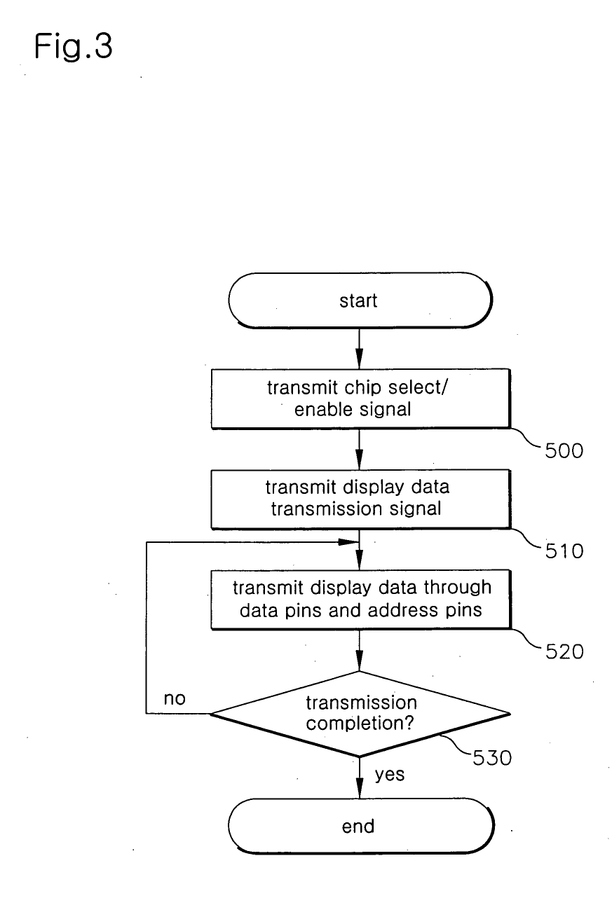

FIG. 2 is a schematic diagram illustrating address pins used for transmitting color display data to the LCD driver 400 in accordance with an embodiment of the present invention. FIG. 3 is a flow chart illustrating a method for transmitting the color display data in accordance with an embodiment of the present invention.

Referring to FIG. 2, the main processor 300 mounted in the MSM chip is electrically connected to the LCD driver 400 through data pins D0˜D15 and address pins A0˜A2, . . .

The main processor 300 transmits, to the LCD driver 400, the color display data to be displayed on an LCD device serving as a display unit of the mobile communication terminal. The main processor 300 is responsible for transmitting control data to the LCD driver 400 in response to a user's command. In detail, the main processor 300 divides color display data of each dot which is expressed as n bits into 16-bit data and 2-bit data. Then, the main processor 300 outputs the 16-bit data through the 16 data pins and simultaneously the remaining 2-bit data through the address pins A0 and A1, thereby transmitting 18-bit display data.

The main processor 300 transmits control data such as LCD brightness control data to the LCD driver 400. At this point, the control data is transmitted to the LCD driver 400 through the data pins. For reference, the main processor 300 includes 16 data pins and 24 address pins.

The LCD driver 400 collects the 18-bit display data received through 18 data pins D0˜D17 and stores the color display data in a predetermined area provided in a memory on a dot-by-dot basis. Furthermore, when the color display data corresponding to one frame is collected, the LCD driver 400 carries out a control operation for driving the LCD.

The LCD driver 400 recognizes the fact that the color display data has been transmitted to appropriately receives and processes the 18-bit color display data transmitted from the main processor 300. For this, the main processor 300 and the LCD driver 400 set address pins A2 and C as signal transmission pins which are used to discriminate a color display data transmission signal and a control data transmission signal. Therefore, when the LCD driver 400 receives a color display data transmission signal through the signal transmission pin C, bit data received through the data pins D16 and D17 is determined as the color display data. For reference, CS shown in FIG. 2 denotes a chip select pin. The LCD driver 400 can be enabled through the chip select pin CS.

Now, a process for transmitting the color display data will be described with reference to FIG. 3.

The main processor 300 transmits a chip select/enable signal through the pin CS at step 500. In response to the chip select/enable signal, the LCD driver 400 is enabled. In order to transmit the color display data, the main processor 300 transmits a color display data transmission signal through the address pin A2 at step 510. When the color display data transmission signal is transmitted, the LCD driver 400 determines bit data received through the data pins D0˜D16 as the color display data and then processes the bit data according to a result of the determination.

Then, the main processor 300 which has transmitted a color display data transmission signal transmits the color display data through the 16 data pins D0˜D15 and the 2 address pins A0 and A1 on a dot-by-dot basis at step 520. In more detail, the main processor 300 divides color display data of each dot which is expressed as n bits(i.e., 18 bits), into color display data of less significant 16 bits and color display data of more significant 2 bits. The 16-bit color display data is assigned to the 16 data pins D0˜D15, and the remaining color display data of the more significant 2 bits is bit-shifted to the address pins A0 and A1, such that the color display data of the more significant 2 bits is transmitted along with the color display data of the less significant 16 bits. Where the color display data of the more significant 2 bits is not bit-shifted, the more significant 2 bits are assigned to address pins A16 and A17.

When the 18-bit display data is simultaneously transmitted through the data pins and the address pins as described above, the LCD driver 400 collects the 18-bit display data simultaneously received through the 18 data pins D0˜D17 and stores the color display data in a predetermined area of the memory on a dot-by-dot basis. When the color display data of one frame is completed, the LCD driver 400 carries out a control operation for driving the LCD device on the basis of the transmitted display data. Consequently, the 260 K colors capable of being expressed as the 18 bits can be implemented.

In accordance with the present invention, the color display data of each dot which is expressed as 18 bits is divided into 16-bit data and 2-bit data. The 16-bit data is transmitted through the data pins and simultaneously the remaining 2-bit data is transmitted through the address pins. Consequently, there can be obtained the effect of simultaneously transmitting the 18-bit color display data through 18 data pins, thereby reducing a time period required to transmit the color display data.

In accordance with another embodiment of the present invention, color display data of 18 bits or more can be transmitted to the LCD driver 400 using only the address pins of the main processor 300.

As described above, the main processor 300 of the MSM chip includes 24 address pins. Since one of the address pins is set and used as a signal transmission pin necessary for discriminating a color display data transmission and a control data transmission, the remaining address pins can be used to transmit the color display data.

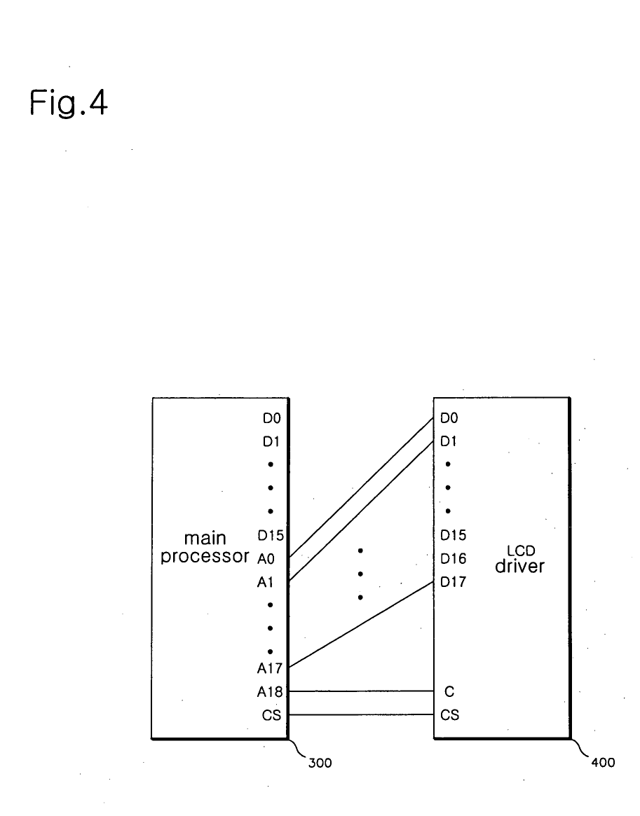

As shown in FIG. 4 as an example, address pins A0˜A17 are set as data transmission pins necessary for transmitting the 18-bit color display data, and an address pin A18 is set as a signal transmission pin necessary for discriminating a color display data transmission and a control data transmission. In this case, the main processor 300 can rapidly transmit the 18-bit color display data to the LCD driver 400 through the address pins so that the 260 K colors can be implemented.

In accordance with a modified embodiment of the present invention, part of the color display data can be transmitted to the LCD driver 400 through global purpose input/output (GPIO) pins instead of the address pins.

That is, the 18-bit color display data necessary for implementing the 260 K colors is divided into the color display data of the less significant 16 bits and the color display data of the more significant 2 bits. The color display data of the less significant 16 bits is outputted through 16previously assigned data pins D0˜D15, and the color display data of the more significant 2 bits is outputted through 2 previously assigned GPIO pins. In this case, the LCD driver 400 collects the 18-bit color display data simultaneously received through 18 data pins D0˜D17. The color display data is stored in a predetermined area designated in a memory on a dot-by-dot basis. When the color display data of one frame is completed, the LCD driver 400 carries out a control operation for driving the LCD on the basis of the transmitted display data. Consequently, the 260 K colors capable of being expressed as the 18 bits can be implemented.

As apparent from the above description, the method and mobile communication terminal in accordance with the present invention can transmit color display data using address pins or global purpose input/output (GPIO) pins as well as 16 data pins, such that 260 K colors capable of being expressed as 18 bits can be implemented without a display data transmission delay.

In accordance with the present invention, the 260 K colors can be easily implemented without increasing the number of data pins mounted in a mobile station modem (MSM) chip for outputting display data.

The preferred embodiments of the present invention have been disclosed for illustrative purposes. Further, those skilled in the art will appreciate that various modifications, additions and substitutions are possible, without departing from the scope and spirit of the invention as disclosed in the accompanying claims.

1. A mobile communication terminal, comprising:
a main processor including a plurality of data pins and a plurality of address pins and transmitting predetermined bits of color display data through the data pins and the address pins; and
a liquid crystal display (LCD) driver receiving the predetermined bits of the color display data transmitted through the data pins and the address pins and driving a liquid crystal display (LCD) device according to the received color display data.

2. The mobile communication terminal as set forth in claim 1, wherein the main processor divides the color display data of each dot expressed as n bits, and carries out a control operation so that partial bit data of the divided color display data is transmitted through the data pins and simultaneously the remaining bit data of the divided color display data is transmitted through some of the address pins.

3. The mobile communication terminal as set forth in claim 2, wherein the LCD driver collects the n-bit color display data transmitted through the data pins and the address pins, and stores the collected color display data in a predetermined area on a dot-by-dot basis.

4. The mobile communication terminal as set forth in claim 1, wherein one of the address pins is used as a signal transmission pin necessary for discriminating a color display data and a control data transmitted through the address pins.

5. The mobile communication terminal as set forth in claim 2, wherein the color display data of each dot is 18-bit data, color display data of less significant 16 bits is transmitted through 16 data pins, and simultaneously color display data of more significant 2 bits is transmitted through 2 address pins.

6. The mobile communication terminal as set forth in claim 5, wherein the color display data of the more significant 2 bits is bit-shifted to the 2 address pins previously assigned and the shifted 2 bits are outputted.

7. A mobile communication terminal, comprising:
a main processor including a plurality of data pins, a plurality of address pins and a plurality of global purpose input/output (GPIO) pins and transmitting predetermined bits of color display data through the data pins and the GPIO pins; and
a liquid crystal display (LCD) driver receiving the predetermined bits of the color display data transmitted through the data pins and the GPIO pins and driving a liquid crystal display (LCD) device according to the received color display data.

8. The mobile communication terminal as set forth in claim 7, wherein the main processor divides the color display data of each dot expressed as n bits, and carries out a control operation so that partial bit data of the divided color display data is transmitted through the data pins and simultaneously the remaining bit data of the divided color display data is transmitted through some of the GPIO pins.

9. The mobile communication terminal as set forth in claim 8, wherein the LCD driver collects the n-bit color display data transmitted through the data pins and the GPIO pins, and stores the collected color display data in a predetermined area on a dot-by-dot basis.

10. The mobile communication terminal as set forth in claim 7, wherein one of the address pins is used as a signal transmission pin necessary for discriminating a color display data and a control data transmitted through the GIPO pins.

11. The mobile communication terminal as set forth in claim 8, wherein the color display data of each dot is 18-bit data, color display data of less significant 16 bits is transmitted through 16 data pins, and simultaneously color display data of more significant 2 bits is transmitted through 2 GPIO pins.

12. A mobile communication terminal, comprising:
a main processor including a plurality of data pins and a plurality of address pins and transmitting a color display data through the address pins; and
a liquid crystal display (LCD) driver receiving the color display data transmitted through the address pins and driving a liquid crystal display (LCD) device according to the received color display data.

13. The mobile communication terminal as set forth in claim 12, wherein one of the address pins is used as a signal transmission pin necessary for discriminating a color display data and a control data transmitted through the address pins.

14. A method for transmitting color display data in a mobile communication terminal including a main processor connected to a liquid crystal display (LCD) driver through a plurality of data pins and a plurality of address pins, comprising the steps of:
outputting a color display data transmission signal to the LCD driver through one of the address pins;
dividing color display data to predetermined bits; and
transmitting partial bit data of the divided color display data to the LCD driver through the data pins and the remaining bit data of the divided color display data to the LCD driver through some of the address pins.

15. The method as set forth in claim 14, wherein the color display data of each dot is 18-bit data, color display data of less significant 16 bits is transmitted through 16 data pins, and simultaneously color display data of more significant 2 bits is transmitted through 2 address pins.

16. A method for transmitting color display data in a mobile communication terminal including a main processor connected to a liquid crystal display (LCD) driver through a plurality of data pins, a plurality of address pins and a plurality of global purpose input/output (GPIO) pins, comprising the steps of:
outputting a color display data transmission signal to the LCD driver through one of the address pins;
dividing color display data to predetermined bits; and
transmitting partial bit data of the divided color display data to the LCD driver through the data pins and the remaining bit data of the divided color display data to the LCD driver through some of the GPIO pins.

17. The method as set forth in claim 16, wherein the color display data of each dot is 18-bit data, color display data of less significant 16 bits is transmitted through 16 data pins, and simultaneously color display data of more significant 2 bits is transmitted through 2 GPIO pins.

18. A method for transmitting color display data in a mobile communication terminal including a main processor connected to a liquid crystal display (LCD) driver through a plurality of data pins and a plurality of address pins, comprising the steps of:
outputting a color display data transmission signal to the LCD driver through one of the address pins; and
transmitting color display data to the LCD driver through a number of address pins.

19. The method as set forth in claim 18, wherein the color display data of each dot is data of 18 bits or more.
